(19) United States
(12) Patent Application Publication
(10) Pub. No.: US 2006/0267561 A1
(43) Pub. Date: Nov. 30, 2006

(54) Power factor correction circuit for DC-DC converters with low resonance current

(75) Inventors: Moshe Domb, Irvine, CA (US); Jackie Tang, Irvine, CA (US)

Correspondence Address: Harold L. Jackson, 14751 Plaza Dr., Ste. N, Tustin, CA, 92780, US

(73) Assignee: Cherokee International Corporation

(21) Appl. No.: 11/139,162

(22) Filed: May 27, 2005

(51) Int. Cl. G05F 1/00

(52) U.S. Cl. 323/222

(57) ABSTRACT

An improvement in a power factor correction circuit with ZVS provides low resonance current. The basic circuit includes a positive input and ground terminal and an output capacitor connected between a positive output terminal and ground. A power factor indicator (Lin) and an output diode (D2) are connected between the positive input and output terminals. A main transistor switch (Q1) periodically connects a node between Lin and D2 to ground to store energy in Lin which is transferred to the output when Q1 is turned off. A resonant indicator (Lr) and an auxiliary transistor switch, connected across Q1, discharges Q1's source drain capacitance prior to turning Q1 on to provide ZVS. The improvement comprises an additional inductor (L2) connected in series between Lin and D2 to isolate D2's reverse recovery current from the resonant current in Lr.

### FIELD OF THE INVENTION

The present invention generally relates to AC to DC power conversion and more particularly to a AC-DC converter with a power factor correction circuit.

### BACKGROUND OF THE INVENTION

A typical power factor correction (“PFC”) circuit, as part of a AC-DC converter, includes a PFC inductor and an output diode connected in series between a DC source and an output capacitor, across which the load is to be connected. A transistor switch, such as an MOSFET, is connected to a node between ground and a node between the PFC inductor and the output diode to regulate the output voltage.

When the transistor switch, e.g., a MOSFET, is on the current through the PFC inductor increases which in turn stores energy in the PFC inductor's magnetic field. This energy is transferred through the output diode to the output capacitor when the switch is turned off.

The efficiency of such a PFC circuit is degraded by the MOSFET drain source capacitance discharge at turn on loss, i.e.,

$$Pcv 2 \text{:} = \frac{1}{2} \cdot Coss \cdot 380 {V}^{2} \cdot f$$

where:
Pcv2 represents the power loss
Coss=the drain source capacitance;
380 V²=the booster output voltage of 380 volts²; and
f=switching frequency.

Moreover, if one tries to reduce the conduction of the transistor switch by using FETs with lower drain source resistance Coss increases. Increasing the transistor switching frequency exacerbates the loss further.

FIGS. 1 and 2 illustrate two PFC booster circuits following current technology. The values of the several components noted in the figures are by way of example only. Referring specifically to FIG. 1 an input voltage Vin, e.g. 130 v, is converted into an output voltage Vo, e.g., 380 v, across an output filter capacitor Cout via a PFC inductor Lin and an output diode D2. A main transistor switch Q1 periodically grounds the node between Lin and D2. A diode D1, resonant inductor Lr and an auxiliary transistor switch Qaux are connected across Q1 to discharge Q1's drain source capacitance before Q1 is turned on to provide zero voltage switching (“ZVS”). D3 and D4 transfer energy stored in Lr to the output when Qaux is turned off. A control and driver circuit controls the gates of Q1 and Qaux, e.g., PWM, to regulate the output voltage in a conventional manner.

The logic of this present art is that the auxiliary FET, Qaux, conducts only for a short duration necessary to discharge Coss from the boost voltage of 380 v down to 0 v to allow the main FET, Q1 to turn on with ZVS. However, this logic has its own shortcomings due to the high resonance current flowing in Quax. The peak current flowing in Qaux (“Iaux pk”)=Iin+_Irr+ires

where:
Iin is the current in the PFC inductor Lin;
Irr is the reverse recovery current in the PFC diode D2; and
Ires is the peak current in the resonance inductor Lr.

See FIG. 3 for the currents and voltages of Q1 and Qaux in FIG. 1 with respect to time where the values of Coss, Lr, C1 and Cout are 800 pf, 4 uh, 0.022 uf and 600 uf, respectively. The top waveform 10 represents the current flowing through Qaux, i.e., IQuax. The resonance current, Ires, is very high because Iaux pk has to overcome Iin+Irr before the diode D2 turns off enabling Lr to discharge Coss from an initial peak current of Iin+Irr. The efficiency of the circuit may actually decrease when adding the ZVS part to the PFC circuit. As will be noted in the top graph of FIG. 3, Qaux conducts for slightly over 300 nanoseconds (“ns”) and reaches a peak current of slightly over 20 amperes. Waveforms 12 and 14 in the bottom graph of FIG. 3 show the drain source (VdsQ1) and gate source (VgsQ1) voltages of Q1 in relation to the conduction of Qaux. The scales for the several waveforms are noted in the figure.

We have discovered that the resonance current flowing in the auxiliary transistor switch can be significantly reduced and the efficiency of a PFC correction circuit with low or zero voltage switching (“ZVS”) of the main switch can be accordingly enhanced by isolating the output diode's reverse recovery current from the resonant current flowing in the auxiliary transistor switch.

### SUMMARY OF THE INVENTION

An improvement in power factor correction circuit with ZVS providing low resonance current, in accordance with the present invention, includes a positive input and ground terminal for connection to a dc source and an output capacitor connected between a positive output terminal and ground. A power factor inductor (Lin) is connected in series with an output diode (D2) between the positive input and output terminals. A main transistor switch (Q1) periodically connects a node between Lin and D2 to ground to store energy in Lin which energy is transferred to the output when Q1 is turned off. A resonant inductor (Lr) and an auxiliary transistor switch (Qaux) are connected in series relationship across Q1, to discharge Q1's internal (source-drain) capacitance prior to turning Q1 on to provide ZVS. An additional inductor is connected in series relationship between Lin and D2 for isolating D2's reverse recovery current from the resonant current in Lr.

The construction and operation of the present invention may best be understood by reference to the following description taken in conjunction with the appended drawings in which like components are given the same reference designation in the several figures including FIGS. 1 and 2 representing the prior art.

### BRIEF DESCRIPTION OF THE DRAWINGS

FIGS. 1 an 2 are schematic diagrams of prior art boost converters with PFC and ZVS;

FIG. 3 is a graph illustrating the voltage and current characteristics versus time of selected components of the circuit of FIG. 1;

FIG. 4 is a schematic diagram of a boost converter with PFC, ZVS and low resonance current in accordance with the present invention;

FIG. 5 is a graph illustrating the voltage and current characteristics versus time of selected components of the circuit of FIG. 4 during the on time of the main transistor switch Q1; and

FIG. 6 is a graph illustrating the voltages and current characteristics versus time of selected components of the circuit of FIG. 4 during the off time of the main transistor switch Q1.

### DESCRIPTION OF THE PREFERRED EMBODIMENT

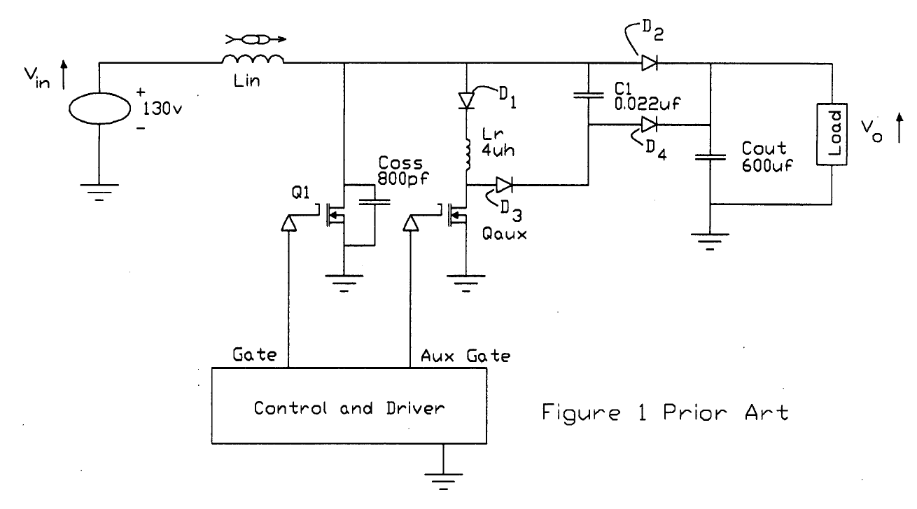

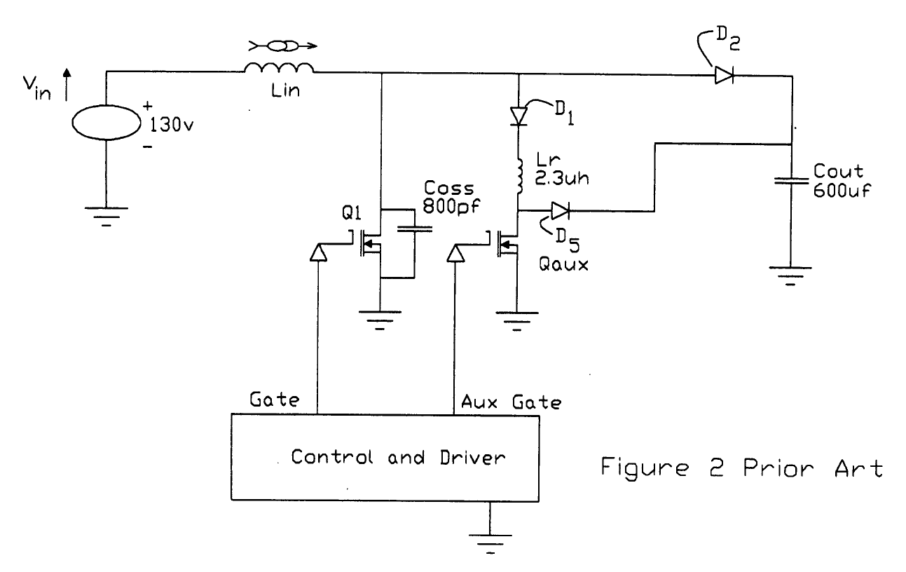

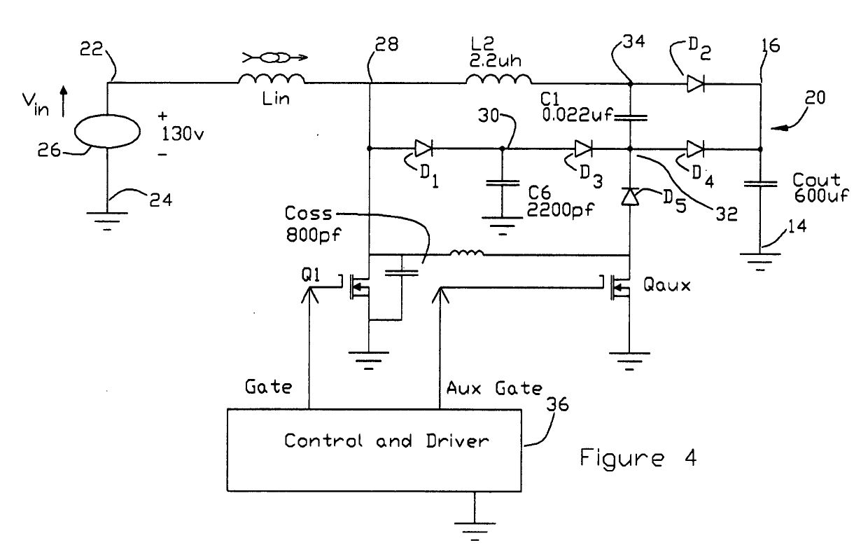

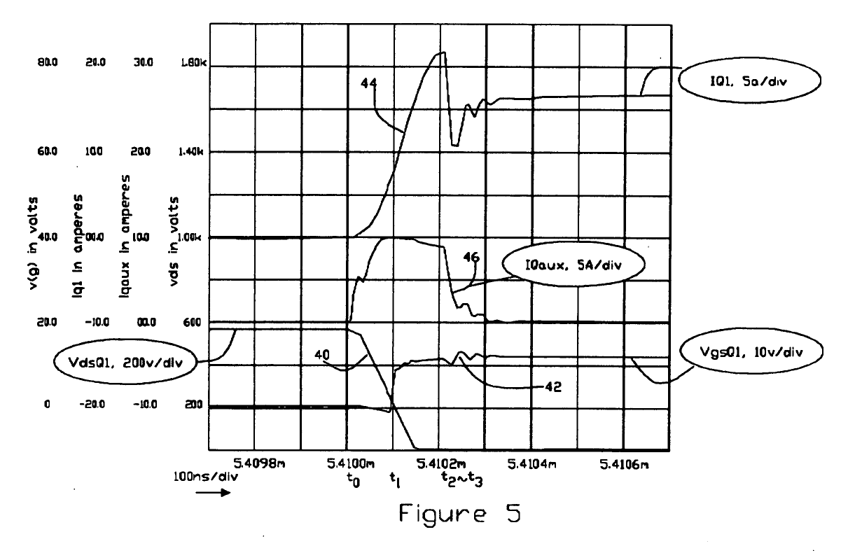

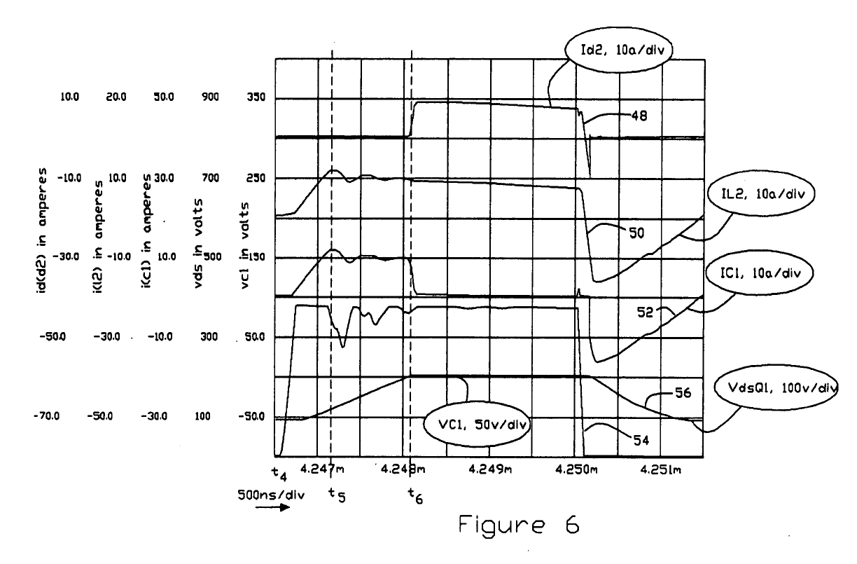

Referring now to FIG. 4 a power converter 20, in accordance with the present invention, includes a positive input terminal 22 and a negative or ground terminal 24 across which a DC source 26 is connected. The DC source may, for purposes of correlation with the waveform diagrams of FIGS. 5 and 6, provide an input voltage of 130 v and may be the output of full wave bridge rectifier, at about 90 VAC, coupled to a conventional ac source. The PFC inductor Lin, discussed previously, is connected in series with an isolation inductor L2 and the output diode D2 in that order between the positive input terminal 22 and a positive output terminal 16. The output capacitor Cout is connected between the terminal 16 and ground to provide an output DC voltage to a load (not shown) connected thereacross. A node 28 between PFC indicator Lin and the isolation inductor L2 is periodically grounded through the main transistor switch Q1, which may be in the form of a MOSFET as shown, with the source and drain electrodes of Q1 connected to ground and the node 28, respectively. The capacitor shown as Coss represents the drain source capacitance of the transistor Q1 and is discharged through a resonant inductor Lr and an auxiliary transistor switch Qaux, also in the form of a MOSFET, as described with respect to FIG. 1. It is to be noted that while MOSFET switches are illustrated insulated gate bipolar transistors or other semiconductor switches could be used. Diodes D1, D3 and D4 are connected in parallel with L2 and D2 as shown with a capacitor C6 connecting the node 30 at the junction of D1 and D2 to ground. A diode D5 is connected in series between the source electrode of Qaux and a node 32 at the junction of D3 and D4. An additional capacitor C1 is connected between node 32 and a node 34 at the junction of isolation inductor L2 and diode D2 to complete the circuit. The anodes and cathodes of the diodes are as shown in the figure. The values of the several components are shown in the figure, by way of example, only.

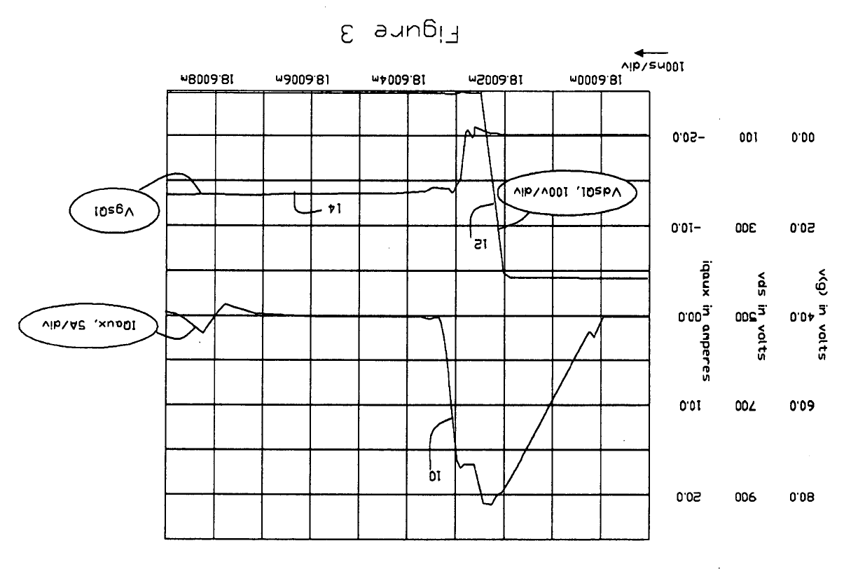

Control signals are applied to the gates of the transistor switches by control and driver circuit 36 to turn the switches on and off as will be described in connection with FIGS. 5 and 6. During the “off period” of Q1, (main FET), the currents in Lin and L2 are equal. As soon as Quax is turned on Coss starts to discharge immediately through Lr and Qaux without having to overcome Iin+Irr as was the case with the circuit of FIGS. 1 and 2. The isolation inductor L2 acts as a “buffer” to isolate the D2's reverse recovery current Irr as well as the current in Lin from the resonance current flowing in Lr to ground through Qaux. The value of the resonance inductor Lr is preferably chosen to discharge Coss within the range of about 50 to 150 ns and typically about 100 ns from the turn on time tₒ of Qaux. FIG. 5 illustrates the currents and voltages corresponding to Q1 and Qaux during the “on” period. Waveforms 40 and 42 represent Q1's drain source (VdsQ1) and gate source (VgsQ1) voltages, respectively, while waveforms 44 and 46 represent the currents flowing through Q1 and Qaux, respectively. For purposes of correlating the waveforms of FIGS. 5 and 6 with FIG. 3, the component values are as follows:

Lin=˜300 uh

L2=2.2 uh

C1=0.022 uf

C6=2200 pf

Cout=600 uf

Coss=800 pf (Q1 drain source capacitance)

It is to be noted that such values are given by way of example only.

Referring again to FIG. 5, at time tₒQaux turns on and commences to discharge Coss. At time t=t1, about 150 ns later, the main FET Q1 turns on with ZVS condition as shown.

At t=t2 the output diode D2 turns off and it's reverse current is freewheeled by C6, D3,C1, L2 and Q1.

At t=t3˜250 ns, Qaux turns off and the current through Lr freewheels through Lr, D5,C1,L2 and charges C1 to typically 40 v to 70 v at t=t4. For the rest of the “on period” of Q1 all the charge that was stored in C6 and the reverse current in L2 has been converted to charge across C1 based on the following equation:

$$\frac{1}{2} \cdot Coss \cdot {( 380 \cdot v )}^{2} + \frac{1}{2} \cdot L 2 \cdot {Irr}^{2} \text{:} = \frac{1}{2} \cdot C 1 \cdot Vc {1}^{2}$$

Where:
380 v=the booster voltage of 380 volts
L2=the inductance of L2
Irr=D2's reverse recovery current

Commencing with the next Q1 “off” period, the current flowing through Lin is initially carried through D1, D3 and D4 to output terminal 16. FIG. 6 illustrates the relevant current and voltages versus time during the off period where waveforms 48, 50 and 52 represent the currents in D2, L2 and C1, respectively, and waveforms 54 and 56 represent the voltages across Q1 and C1, respectively. The scales for the currents, voltages and time are as indicated in the figure.

The current through L2 builds up and at t=t5 the current in Lin and L2 equalize and the current in PFC inductor L2 flows through L2, C1 and D4 to Cout while charging the charge on C1 from Vc1 as noted by the above equation, towards −0.8 v.

At t=t6 when Vc1 equals approximately −0.8 v, D2 carries all the current during the rest of the “off” period for Q1.

It is to be noted that the above referenced values of the several components and resulting voltages and currents are given by way of example only.

There has thus been described an improvement in a boost converter with PFC and ZVS. Modifications of the invention will occur to those skilled in the art without involving a departure from the spirit and scope of the invention as defined by the appended claims.

What is claimed is:

1. An improvement in a power factor correction circuit for DC-Dc converters, the circuit having a positive input and output terminal and a ground terminal, an output capacitor connected between the output terminal and ground, a power factor inductor (“Lin”) connected in series with an output diode (“D2”) between the positive input and output terminals, a main transistor switch (“Q1”) for periodically connecting Lin to ground to store energy in Lin which is transferred through D2 to the output terminal when Q1 is off, and a resonant inductor (“Lr”) and an auxiliary transistor (“Qaux”) connected in series across Q1 for discharging Q1's internal capacitance prior to turning Q1 on to provide low or ZVS, the improvement comprising:
an auxiliary inductor (“L2”) connected in series between Lin and D2 for substantially isolating the reverse recovery current in D2 from Qaux during the conduction of Qaux.

2. The invention of claim 1 further including at least one capacitor (“C1”) coupled to D2 for accumulating a charge in accordance with D2's reverse recovery current.

3. The invention of claim 3 wherein Lin and L2 are connected together at a node with Q1 connected between the Lin/L2 node and ground, wherein L2 and D2 are connected together at a node with one terminal of Q1 connected to the L2/D2 node, a pair of diodes (“D1 and D3”) connected in series between the Lin/L2 junction and the other terminal of C1 and a capacitor (“C6”) connected between the D1/D3 junction and ground.

4. A power factor correction circuit for DC-DC converters comprising:
a) a positive and negative input terminal across which a dc voltage is applied;
b) a positive and common negative output terminal with an output capacitor connected thereacross;
c) a power factor correction (“PFC”) inductor, an isolation inductor, and an output diode coupled in series relationship in that order between the positive input and output terminals;
d) a main semiconductor switch having an on and off state coupled between the negative terminal and the end of the PFC inductor remote from the positive input terminal, the main switch having an internal capacitance which accumulates a charge in accordance with the magnitude of the output voltage when in the off state;
e) a resonant inductor and an auxiliary transistor switch coupled in parallel with the main switch, the auxiliary switch having an on and off state and being arranged to discharge the internal capacitance of the main switch through the resonant inductor in the on state; and
f) control means for applying control signals to the main and auxiliary switches to periodically turn the main and auxiliary switches on and off with the auxiliary switch being turned on a sufficient time before the main switch is turned on to discharge the internal capacitance of the main switch through the resonant inductor.

5. The power factor correction circuit of claim 4 wherein the isolation inductor has a value sufficient to isolate the reverse recovery current flowing in the output diode in it's off state from the current flowing in the resonant inductor.

6. The power conversion circuit of claim 5 wherein the value of the resonant inductor is sufficient to substantially discharge the internal capacitance of the main switch.

7. The power conversion circuit of claim 6 wherein the switches are MOSFETs.

8. The power conversion circuit of claim 7 wherein the resonant inductor value is sufficient to discharge the main switch's internal capacitance in about 100 ns.
